(19) United States
(12) Patent Application Publication
(10) Pub. No.: US 2002/0134345 A1
(43) Pub. Date: Sep. 26, 2002

(54) Combustion chamber system

(76) Inventor: Joseph S. Adams, Salt Springs Island (CA)

Correspondence Address: Eugene S. Stephens, Eugene Stephens & Associates, 56 Windsor Street, Rochester, NY, 14605, US

(21) Appl. No.: 10/050,416

(22) Filed: Jan. 16, 2002

Related U.S. Application Data
(62) Division of application No. 09/813,058, filed on Mar. 20, 2001.

(51) Int. Cl. F02B 19/16

(52) U.S. Cl. 123/285

(57) ABSTRACT

A combustion chamber system having a pre-combustion chamber in communication with a final combustion chamber, where the length of said pre-combustion chamber is substantially greater than its width. The pre-combustion chamber can be curved along all or part of its length, and such curved chamber parts can be nested.

### TECHNICAL FIELD

Pre-combustion and final combustion chamber systems designed for intermittent linear motors.

### BACKGROUND OF THE INVENTION

I have pioneered the use of primary and final combustion chamber systems in intermittent linear motors. In these systems, combustion initiated in a primary combustion chamber generates a flame front that drives and compresses unburned fuel and air into a final combustion chamber. This greatly increases the work output of the system. My prior patents, particularly U.S. Pat. Nos. 4,365,471 and 4,510,748, and 4,665,868 represent some of my efforts in this area.

In operation, both chambers in a system of this type are first charged with a mixture of fuel and air. The mixture in the pre-combustion chamber is then ignited. The flame front generated moves through the pre-combustion chamber, pushing unburned fuel and air in front of it into the final combustion chamber. The flame front then passes a check valve between the two chambers and ignites the compressed mixture in the final combustion chamber. This process elevates combustion pressure in the final combustion chamber, leading to more efficient combustion in the final combustion chamber. These higher pressures can more effectively and powerfully perform useful work, such as driving a fastener.

### SUMMARY OF THE INVENTION

I have now discovered that increasing a length-to-width aspect ratio of a pre-combustion chamber significantly improves its performance. Making a pre-combustion chamber especially long runs counter to the recognized advantages of designing combustion chamber systems to be as compact as possible, but I have found that a long and narrow pre-combustion chamber can push more unburned fuel and air ahead of a flame front into a final combustion chamber than is possible with a normally short and wide pre-combustion chamber. I have also discovered that especially elongated pre-combustion chambers can be either straight and generally smooth or curved or folded into non-linear paths. I have experimented with several performance varying parameters that produce significantly more compression in a final combustion chamber and thereby dramatically increase power output. Although I prefer to allow unburned fuel and air to pass relatively unimpeded from the pre-combustion chamber into the final combustion chamber, I have found that a check valve blocking any high pressure back flow from the combustion chamber back into the pre-combustion chamber is important to enhanced performance.

### DESCRIPTION OF THE DRAWINGS

FIG. 1 provides a cross-sectional schematic view from the side of a first embodiment of the invention.

FIG. 2 provides a cross-sectional schematic view from the side of a second embodiment of the invention in which the pre-combustion chamber is curved.

FIG. 3A provides a cross-sectional schematic view from the side of a third embodiment of the invention in which the sections of a curved pre-combustion chamber are arranged in series and nested for compactness.

FIG. 3B provides a cross-sectional schematic view from above the curved and nested sections of the pre-combustion chamber illustrated in FIG. 3A.

FIG. 4 provides a cross-sectional schematic view from the side of a fourth embodiment of the invention in which the pre-combustion chamber and the final combustion chamber are approximately equal in volume with the pre-combustion chamber having a length to width ratio of approximately four to one.

FIG. 5A provides a cross-sectional schematic view from the side of a fifth embodiment of the invention having a pre-combustion chamber with two curved sections surrounding a straight final combustion chamber.

FIG. 5B provides a cross-sectional schematic view from above the first pre-combustion chamber section.

FIG. 5C provides a cross-sectional schematic view from above the second pre-combustion chamber section.

FIGS. 6A-C are schematic views similar to the views of FIGS. 5A-C and showing a somewhat different arrangement of combustion and pre-combustion chambers that include an intake valve and an exhaust valve.

FIGS. 7A-C schematically show another preferred embodiment of an annular pre-combustion chamber surrounding a cylindrical final combustion chamber shown in vertical cross-sections in FIG. 7A and in horizontal cross-sections in FIGS. 7B and 7C.

### DESCRIPTION OF THE INVENTION

The interests of compact mechanical design have resulted in prior combustion systems, including my own, having a short length with diameters or widths generally much larger than their lengths. Experiments in lengthening pre-combustion chambers so that their length to width aspect ratios are greatly increased has revealed that higher aspect ratio pre-combustion chambers are much more effective at forcing unburned fuel and air ahead of an advancing flame front into a final combustion chamber. This improvement increases pressure in the final combustion chamber before ignition occurs there, and this greatly increases the power obtainable from combustion in the final combustion chamber.

The reasons why elongated pre-combustion chambers accomplish this effect remain unclear, but experimental evidence verifies that elongated pre-combustion chambers do succeed in forcing more unburned fuel and air into the final combustion chamber for an increased power output. It is reasonable to assume that the increased amount of fuel and air pumped into a final combustion chamber by an elongated pre-combustion chamber occurs in advance of a flame front proceeding from an ignition end of the pre-combustion chamber to a discharge end of the pre-combustion chamber communicating with the final combustion chamber. The improvement in power output from the final combustion chamber can be increased by as much as 50%, simply by elongating a pre-combustion chamber to an optimum aspect ratio.

I have tested combustion chamber systems with straight elongated pre-combustion chambers having length to width ratios over a broad range. Some improvement in performance occurred when the aspect ratio reached 2 to 1. Better performance occurred in a range between 4 to 1 and 16 to 1, and peak performance occurred at approximately 10 to 1. These results show that the performance improvement of an elongated linear pre-combustion chamber tends to track a bell shaped curve having its peak centered at an aspect ratio of approximately 10-1.

Further, I have found that any discontinuities or edges that would cause turbulence in straight pre-combustion chambers should be avoided, as they tend to degrade output power. I have also determined that pre-combustion chambers having round, oval, rectangular, or other cross sections can all function well as long as their length is substantially greater than their average width. The elongated shapes of pre-combustion chambers achieving these improvements have the additional advantage of making it easier to scavenge exhaust gases.

I have also discovered that elongated pre-combustion chambers substantially increasing piston power output can be curved or folded. My experiments indicate that higher aspect ratios for curved or folded pre-combustion chambers produce similar performance advantages. In addition, the flame front created in such elongated and curved pre-combustion chamber propagates must faster. Curving an elongated pre-combustion chamber along its length seems to shift the bell-shaped curve described in the preceding paragraph as well as decrease overall burn time in the pre-combustion chamber. Thus, I have found that by curving or folding an elongated pre-combustion chamber, I can achieve similarly increased power and a shorter burn time at significantly higher aspect ratios in the range of 15-1 to 30-1, for example. These chambers can be formed from curved sections that are joined in series, nested together and/or combined with straight combustion chambers or combustion chamber sections to form compact assemblages achieving the advantages of this invention.

I have also discovered that an aspect ratio of width to thickness of elongated pre-combustion chambers can affect performance. For example, an otherwise successfully elongated pre-combustion chamber having a rectangular cross-section with a high aspect ratio of width to thickness can fail to perform well. In other words, as an elongated pre-combustion chamber approaches a thin, ribbon shape, it can become too constricted to succeed in pumping unburned fuel and air into a final combustion chamber. My experiments indicate that a width to thickness aspect ratio for elongated pre-combustion chambers is best kept at 4-1 or less.

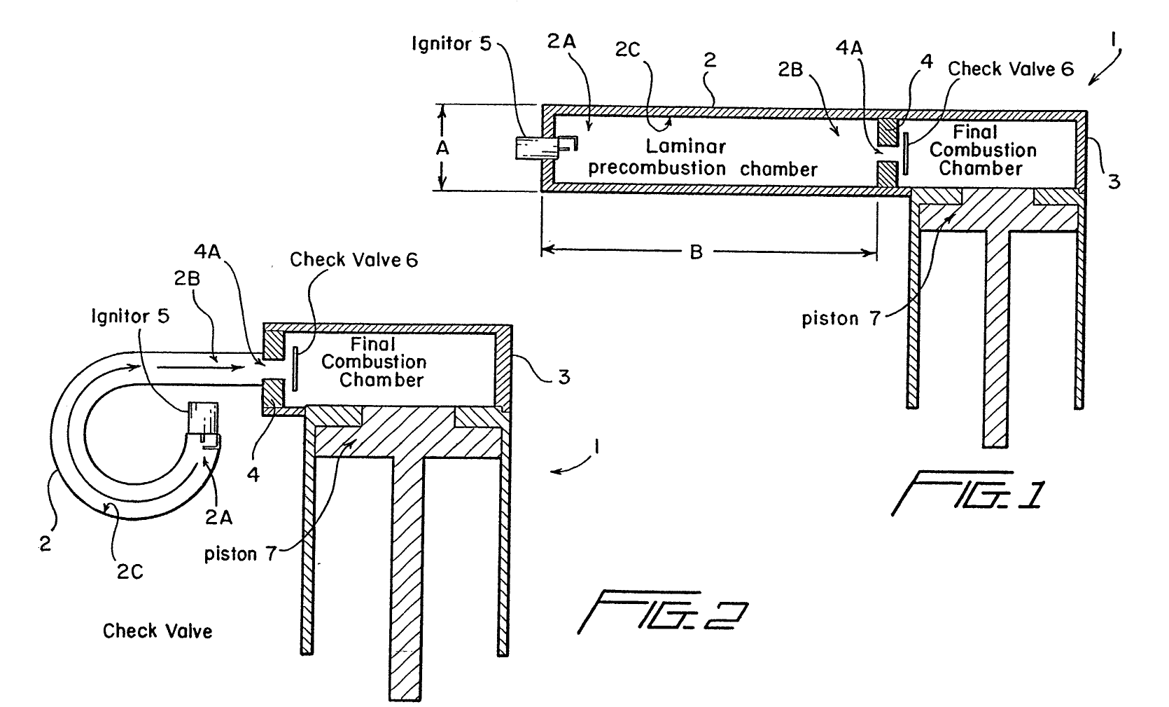

In the embodiment of FIG. 1, as in the other embodiments illustrated, the combustion chamber system (denoted generally by arrow 1) has a pre-combustion chamber or plenum 2 and a final combustion chamber or plenum 3 separated by a combustion control wall 4. Final combustion plenum 3 is adjacent to the second end (denoted by arrow 2B) of pre-combustion plenum 2. An aperture (denoted by arrow 4A) provides an opening for the flame front generated in pre-combustion plenum 2 by igniter 5 to pass through control wall 4 and enter final combustion plenum 3. Ignition of the fuel and air mix in final combustion plenum 3 then drives piston 7.

In this embodiment, unlike prior art embodiments, pre-combustion plenum 2 has a length “B” that is substantially greater than its width “A”. The ratio of length B to width A, or the aspect ratio of pre-combustion plenum 2, is at least two to one. Check valve 6 is arranged next to aperture 4A to allow free flow of a fuel and air mixture from pre-combustion chamber 2 into final combustion chamber 3. For this purpose, check valve 6 is preferably arranged to minimally impede forward flow from chamber 2 to chamber 3. When combustion initiates in final combustion chamber 3, the pressure there rapidly increases, and this closes check valve 6 to limit back flow from chamber 3 to chamber 2.

The interior surface (denoted by arrow 2C) bounding and defining pre-combustion plenum 2 is generally smooth and free of protrusions or rough edges. The average distance across chamber 2 or between opposed wall surfaces 2C of chamber 2 constitutes the width A.

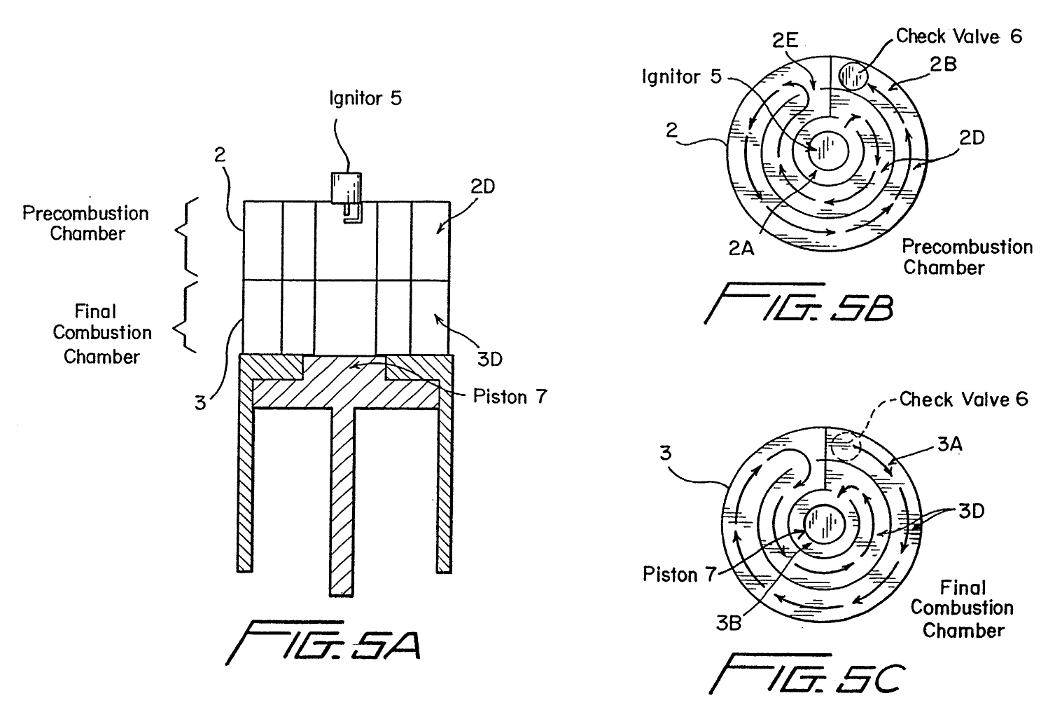

The improvement afforded by increasing the aspect ratio of combustion system 1 can be as much as a 50% increase in power output of piston 7. A variation of the embodiment of FIG. 1 appears in FIG. 4 where the pre-combustion chamber 2 is shown aligned with final combustion chamber 3. The volumes of the pre-combustion and combustion chambers of the embodiment of FIG. 4 are approximately equal, which is known to produce satisfactory increases in power output, and pre-combustion chamber 2 is illustrated with a length to width aspect ratio of approximately 4-1.

The embodiment illustrated in FIG. 2 has a pre-combustion plenum 2 that is curved. This shape was explored as a possible space-saving measure. It allows plenums with higher aspect ratios to achieve results similar to those attained using elongated linear plenums with smaller aspect ratios. In this embodiment and in the other curved embodiments illustrated, the length of a plenum is measured from end to end, equidistant from interior surfaces 2C, through the interior of the plenum.

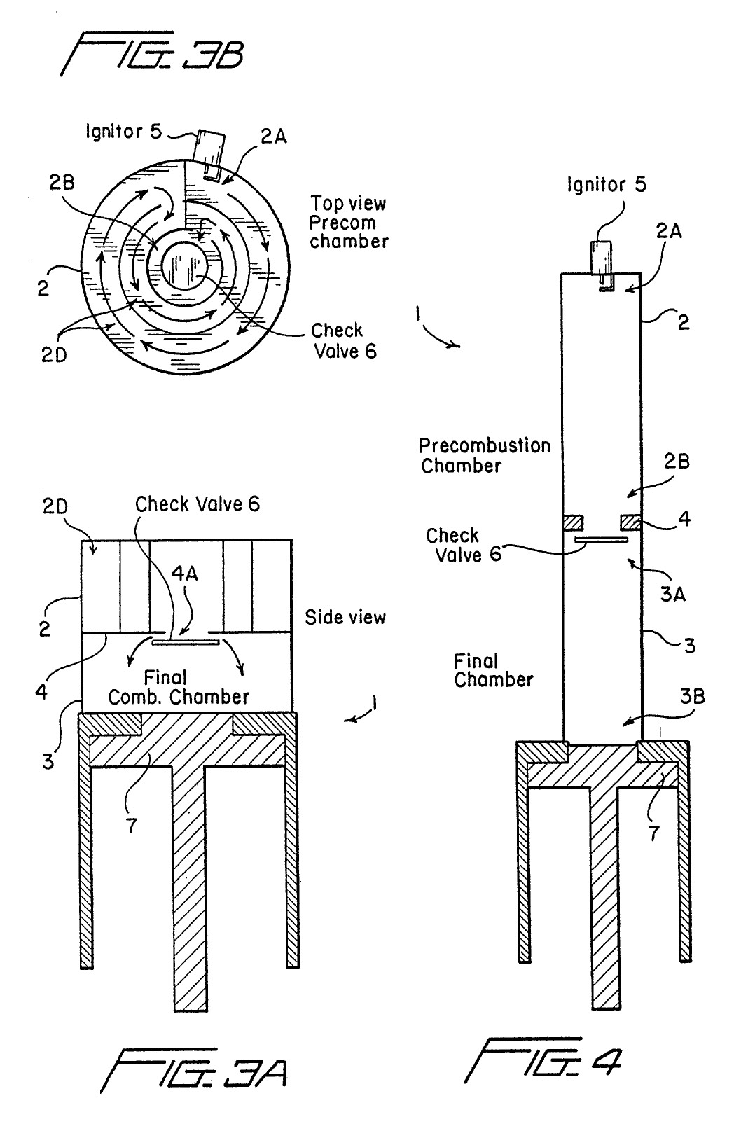

As a further space-saving measure, the embodiment illustrated in FIGS. 3A and B features a pre-combustion plenum 2 that includes a plurality of curved sections (denoted by arrows 2D) arranged in series and nested together. The overall pre-combustion plenum 2 could, however, form an “S” shape or a spiral or have some combination of straight and curved sections. Curved pre-combustion chambers such as shown in FIGS. 3A and B are conveniently formed by different diameters of cylinders arranged co-axially.

A flame front initiated by ignition in region 2A of an outer portion of pre-combustion chamber 2D as shown in FIG. 3A travels first around an outer periphery and then enters an inner periphery. The flame front traveling around inner periphery 2D enters a second end of the pre-combustion plenum at inner chamber 2B where it passes through check valve 6 into final combustion chamber 3. Alternatively, ignition could be initiated in a central chamber so that a flame front proceeded from there around an inner periphery and then into an outer periphery before entering a final combustion chamber. Either way, the curved and folded advance of a flame front in pre-combustion chamber portions 2D forces unburned fuel and air through check valve 6 and into final combustion chamber 3 to increase the pressure of unburned fuel and air in final chamber 3. Such a pressure increase significantly increases combustion power in chamber 3 applied to driving piston 7.

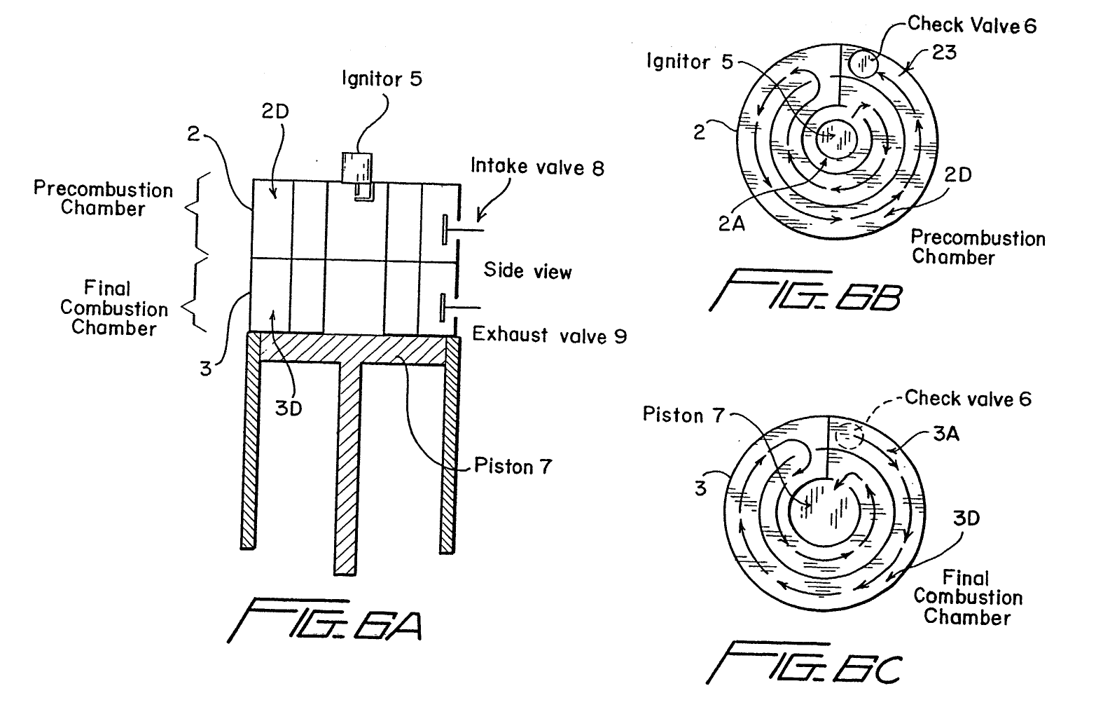

FIGS. 5A-C illustrate an embodiment forming pre-combustion chamber 2 from inner and outer curving sections 2D that are connected via an opening 2E. A central igniter 5 initiates a flame front that proceeds around inner periphery 2D and then around outer periphery 2D to check valve 6 where the flame front enters final combustion chamber 3. Chamber 3 is also formed of curved inner and outer sections 3D that lead to a centrally arranged piston 7.

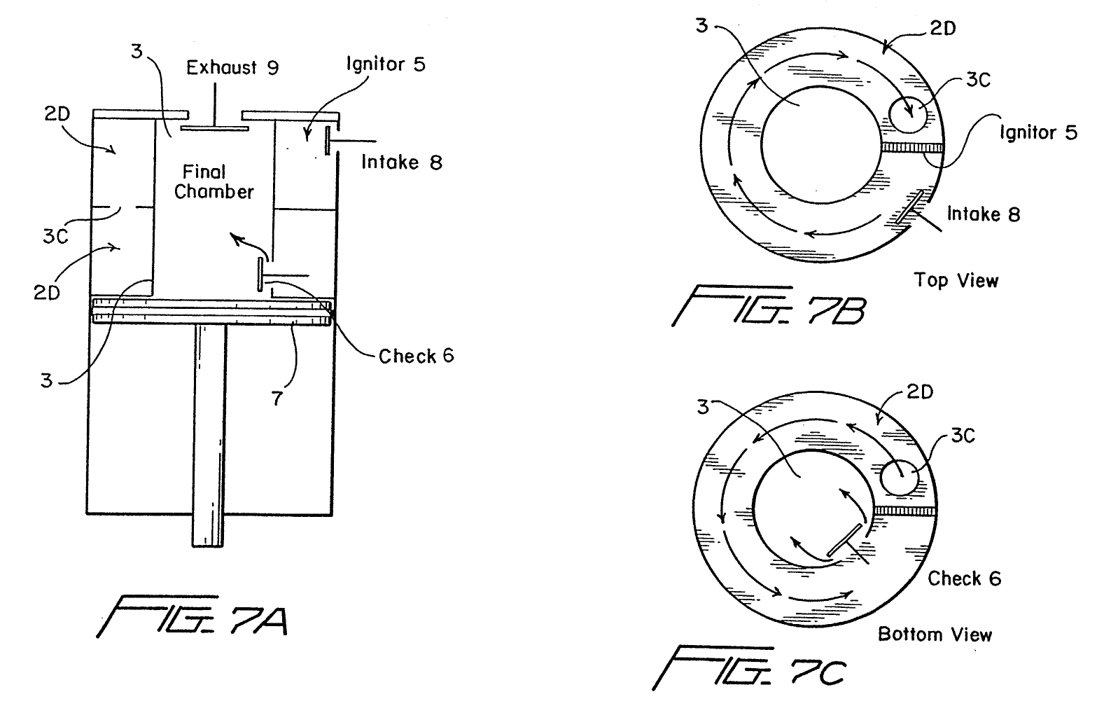

The same arrangement of pre-combustion and final combustion chambers is shown in FIGS. 6A-C with the additional benefit of an intake valve 8 arranged in an outer wall of pre-combustion chamber 2D and exhaust valve 9 arranged in an outer wall of final combustion chamber 3. This compactly accommodates exhaust purging and fuel and air intake needs.

Another variation of curved and stacked pre-combustion and combustion chambers is shown in FIGS. 7A-C. With such an arrangement, igniter 5 initiates combustion that proceeds around an annular upper pre-combustion chamber 2D, through an opening 3C, and into a lower pre-combustion chamber 2D that leads to check valve 6 and entry into cylindrical final combustion chamber 3. A pre-combustion flame front enters final combustion chamber 3 near piston 7 after chamber 3 has received additional unburned fuel and air from pre-combustion chamber 2D. Exhaust from cylindrical chamber 3 occurs through valve 9 at an end of chamber 3, and intake to pre-combustion chamber 2D occurs through valve 8, preferably arranged near igniter 5.

As suggested by the different illustrated embodiments, an endless variety of configurations can implement an elongated pre-combustion chamber effectively increasing the power output obtainable from a final combustion chamber. Many different geometrys and proportions are available to give such arrangements substantially increased power output.

Check valve 6 should, as previously mentioned, be as free flowing as possible. I have satisfactorily tested check valves that are normally open as well as check valves that are normally closed. In either case, the check valve 6 preferably allows a relatively free flow of gases from the pre-combustion plenum 2 to the final combustion plenum 3 and closes when the fuel and air mix in the final combustion plenum 3 is ignited. It is also desirable in some applications, in order to scavenge exhaust gases or to distribute unburned fuel and air through the system, to make the check valve 6 free flowing in both directions at low. pressures. The increased pressure that promptly follows ignition in final combustion chamber 3 quickly closes any check valve 6 so as to limit back flow into. pre-combustion chamber 2.

Check valve 6 an also be arranged to quench a pre-combustion chamber flame front after admitting unburned fuel and air into a final combustion chamber. An igniter in the final chamber can then initiate combustion there.

I claim:

1. A combustion chamber system, comprising:
a. a pre-combustion plenum defined by a pre-combustion plenum surface with a first end and a second end and a length substantially greater than its width, where the distance within said pre-combustion plenum between said first end and said second end defines the pre-combustion plenum length and the pre-combustion plenum width is defined as the average width thereof;
b. a final combustion plenum in communication with said pre-combustion plenum; and
C. a check valve that limits fluid flow from the final combustion plenum to the pre-combustion plenum after combustion initiates in the final combustion plenum.

2 A combustion chamber system as described in claim 1, wherein said pre-combustion plenum is substantially straight.

3. A combustion chamber system, as described in claim 1, wherein said pre-combustion plenum length is at least approximately two times greater than the pre-combustion plenum width.

4. A combustion chamber system, as described in claim 1, wherein said pre-combustion plenum length is at least approximately four times greater than the pre-combustion width.

5. A combustion chamber system, as described in claim. 1, wherein said pre-combustion plenum length is approximately ten times greater than the pre-combustion plenum width.

6. A combustion chamber system, as described in claim 1, wherein said pre-combustion plenum surface is generally smooth.

7 A combustion chamber system, as described in claim 1, wherein the volume of the pre-combustion plenum and the final combustion plenum are approximately equal.

8. A combustion chamber system, as described in claim 1, wherein at least one portion of said pre-combustion plenum is curved lengthwise.

9. A combustion chamber system, as described in claim 8, wherein said pre-combustion plenum includes a plurality of sections arranged in series, and at least one of those sections is curved lengthwise.

10. A combustion chamber system, as described in claim 9, wherein said plurality of sections includes at least two sections curved lengthwise, and these two sections are concentrically arranged around a single axis.

11. A combustion chamber system having a pre-combustion chamber with side walls, a first end and a second end, where combustion of a mixture of fuel and air in said pre-combustion chamber is initiated proximate said first end generating a flame front that pushes unburned fuel and air through an aperture in said second end into a final combustion chamber, where the distance within said pre-combustion chamber between said first end and said second end defines the pre-combustion chamber length and the pre-combustion chamber width is defined as the average width thereof, wherein the improvement comprises:
a. the pre-combustion chamber length being substantially greater than the pre-combustion chamber width; and
b. a check valve in said aperture limiting communication between said final combustion chamber and said pre-combustion chamber after combustion initiates in said final combustion chamber.

12. A combustion chamber system as described in claim 11, wherein said pre-combustion chamber is substantially straight.

13. A combustion chamber system, as described in claim 11, wherein said pre-combustion chamber length is at least approximately two times greater than the pre-combustion chamber width.

14. A combustion chamber system, as described in claim 11, wherein said pre-combustion chamber length is at least approximately four times greater than the pre-combustion chamber width.

15. A combustion chamber system, as described in claim 11, wherein said pre-combustion chamber length is approximately ten times greater than the pre-combustion chamber width.

16. A combustion chamber system, as described in claim 11, wherein said pre-combustion chamber surface is generally smooth.

17. A combustion chamber system, as described in claim 11, wherein the volume of the pre-combustion chamber and the final combustion chamber are approximately equal.

18. A combustion chamber as described in claim 11, wherein at least one portion of said pre-combustion chamber is curved lengthwise.

19. A combustion chamber system, as described in claim 18, wherein said pre-combustion chamber includes a plurality of sections arranged in series, and at least one of those sections is curved lengthwise.

20. A combustion chamber system, as described in claim 19, wherein said plurality of sections includes at least two sections curved lengthwise, and these two sections are concentrically arranged around a single axis.

21. A combustion chamber system driving a linear engine piston in a final combustion chamber communicating with a pre-combustion chamber in which combustion is initiated, the system comprising:
a. the pre-combustion chamber having a length substantially greater than a width, the length being defined by a distance from a first end of the pre-combustion chamber remote from the final combustion chamber to a second end of the pre-combustion chamber communicating with the final combustion chamber, and the width being defined by an average distance between side walls extending between the first and second ends; and
b. a check valve arranged at the second end to allow free flow of unburned fuel and air from the pre-combustion chamber into the final combustion chamber in advance of a flame front proceeding from the first end to the second end, the check valve thereafter limiting fluid flow from the final combustion chamber back into the pre-combustion chamber.

22. A combustion chamber system as described in claim 21, wherein the pre-combustion chamber is substantially linear and smooth.

23. A combustion chamber system as described in claim 21, wherein the length is at least twice the width.

24. A combustion chamber system as described in claim 21, wherein the length is at least four times the width.

25. A combustion chamber system as described in claim 21, wherein the length is at least ten times the width.

26. A combustion chamber system as described in claim 21, wherein the side walls include curves so that the pre-combustion chamber is non-linear.
